(19) United States
(12) Patent Application Publication
(10) Pub. No.: US 2023/0016893 A1
(43) Pub. Date: Jan. 19, 2023

(54) Laser cutting of a pre-coated steel blank and associated blank

(71) Applicant: ArcelorMittal, Luxembourg (LU)

(72) Inventors: Quentin BERNARDI, Montataire (FR); Bernard LUQUET, Montataire (FR)

(21) Appl. No.: 17/785,252

(22) PCT Filed: Dec. 19, 2019
(86) PCT No.: PCT/IB2019/061122

§ 371 Date: Jun. 14, 2022

(51) Int. Cl. B23K 26/38; B32B 15/01; C22C 38/50; C22C 38/48; C22C 38/44; C22C 38/42; C22C 38/06; C22C 38/04; C22C 38/02; C22C 38/00

(52) U.S. Cl. CPC B23K 26/38; B32B 15/012; C22C 38/50; C22C 38/48; C22C 38/44; C22C 38/42; C22C 38/06; C22C 38/04; C22C 38/02; C22C 38/002; C22C 38/001; B32B 2307/732

(57) ABSTRACT

Method for producing a precoated steel blank including the successive steps of: —providing a precoated steel strip including a steel substrate having, on at least one of its main faces, a precoating, the precoating including an intermetallic alloy layer and a metallic layer extending atop said intermetallic alloy layer, the metallic layer being a layer of aluminum, a layer of aluminum alloy or a layer of aluminum-based alloy, —laser cutting the precoated steel strip in order to obtain at least one precoated steel blank, the precoated steel blank including a laser cut edge surface resulting from the laser cutting operation, the laser cut edge surface including a substrate portion and a precoating portion, wherein the laser cutting is carried out in such a way that the substrate portion of the laser cut edge directly resulting from the cutting operation has an oxygen content greater than or equal to 15% in weight.

The present invention concerns a method for producing a precoated steel blank from a precoated steel strip comprising a steel substrate having, on at least one of its faces, a precoating, the precoating comprising an intermetallic alloy layer and a metallic layer extending atop the intermetallic alloy layer, the metallic layer being a layer of aluminum, a layer of aluminum alloy or a layer of aluminum-based alloy.

### BACKGROUND

Steel parts for motor vehicles can be produced using the following method. First, a precoated steel strip, generally obtained through hot-dip coating, is provided and cut into blanks through laser cutting. Each blank is then prepared for welding by removing the metallic layer in a removal zone adjacent the cut edge through laser ablation and the thus prepared blanks are laser welded together to create a welded blank. This welded blank is then hot stamped and press-hardened to obtain the final part.

Such steel parts are used in particular in the automotive industry, and more particularly for the manufacturing of anti-intrusion parts, structural parts or parts that contribute to the safety of automotive vehicles.

The use of laser cutting to prepare the individual steel blanks affords many industrial advantages such as a very good cut face quality, the possibility of attaining very high geometrical precision of the cut shape and the possibility to process very high strength steels. Laser cutting also affords more flexibility than mechanical cutting, because there is no need to produce a new cutting die to change the blank shape.

### SUMMARY OF THE INVENTION

Laser cutting can be performed on blanks which have been mechanically cut from the steel coil. Laser cutting can also be performed directly on the coil, in which case it is also known as laser blanking. Thanks to the emergence of high-power industrial lasers for laser cutting, laser blanking is becoming a viable option in the industry, advantageously dispensing from the intermediate mechanical cutting step performed on the coil.

However, Laser cutting also presents several limitations. One of them is the presence of aluminum on the cut edge in the case of laser cutting of aluminized press hardening steels.

This aluminum, which is not removed by the subsequent laser ablation process, is introduced into the weld metal zone during laser welding and results in an increased aluminum content in the weld metal zone. Aluminum is a ferrite-forming element in solid solution in the matrix and therefore prevents the transformation into austenite which occurs during the step preceding the hot forming. Consequently, it is no longer possible to obtain a fully martensitic or bainitic structure in the weld joint during the cooling after the hot forming and the weld joint will contain ferrite.

As a result, the weld joint of the steel part exhibits, after press-hardening, a hardness and mechanical strength which are lower than those of the two adjacent blanks.

It is possible to mechanically clean the edges in order to remove the aluminum pollution. However, the inventors have found that when using the laser cutting parameters known in the prior art, the aluminum pollution on the cut edges is difficult to remove mechanically, because the aluminum particles exhibit a high adhesion to the cut edge. It is therefore necessary to implement costly measures such as scrubbing or grinding of the edges to ensure that the aluminum pollution is efficiently removed. This means that the manufacturer needs to invest in specific tools and needs to dedicate part of its production time and workshop space to this specific task.

The term brushing designates a process whereby the edge is cleaned using a brush equipped with hard bristles. Rotating brushes that move along the edge are commonly used. The term scrubbing designates a process whereby the edge is cleaned using an abrasive belt which scrubs the edge using a certain amount of normal effort on the edge to obtain the desired result. The term grinding designates a process whereby the edge is cleaned by milling it on a depth for example of 0.1 mm to 0.3 mm. In terms of processing cost and maintenance cost, brushing is much easier and less costly to implement and maintain than both scrubbing and grinding.

International Patent Application PCT/IB2017/056547, now published as WO2019077395 A1 on Apr. 25, 2019, discloses a method to minimize the amount of aluminum which is deposited on the laser cut edge by adjusting the laser cutting parameters. The drawback of such a method is that it lowers the cutting productivity, thereby increasing the production costs.

It is an object of the present invention to provide a method to produce a precoated steel blank having a cut edge surface that can easily be cleaned to remove the aluminum pollution down to a level that is acceptable for the subsequent welding operation. A further aim of the current invention is a method to produce a precoated steel blank having a cut edge surface that can be directly used for laser welding, without requiring additional cleaning.

The present invention provides a method for producing a precoated steel blank comprising the successive steps of:
providing a precoated steel strip comprising a steel substrate having, on at least one of its main faces, a precoating, the precoating comprising an intermetallic alloy layer and a metallic layer extending atop said intermetallic alloy layer, the metallic layer being a layer of aluminum, a layer of aluminum alloy or a layer of aluminum-based alloy,
laser cutting said precoated steel strip in order to obtain at least one precoated steel blank, said precoated steel blank comprising a laser cut edge surface resulting from the laser cutting operation, said laser cut edge surface comprising a substrate portion and a precoating portion, wherein the laser cutting is carried out in such a way that the substrate portion of the laser cut edge directly resulting from the cutting operation has an oxygen content greater than or equal to 15% in weight.

The inventors have found that the above described method allows to produce laser cut precoated steel blanks for which the aluminum pollution on the edges resulting from the cutting process is easy to remove in a subsequent brushing operation. The inventors have also found that such a precoated steel blank can be directly used for laser welding, without brushing the edge before welding.

According to other optional features of the invention, considered alone or according to any possible technical combination:
the laser cutting is performed using an assist gas containing at least 10% of Oxygen in weight and most preferably at least 18% of Oxygen in weight.
the laser cutting is performed using pure oxygen as an assist gas.
the product of the linear energy of the laser used for the laser cutting operation by the oxygen content in volume % of the assist gas is greater than or equal to 0.09 kJ/cm.
the brushing operation is performed after the laser cutting on at least part of the laser cut edge to form a brushed cut edge, said brushed cut edge comprising a brushed substrate portion and at least one brushed precoating portion.
the aluminum content in weight of the brushed substrate portion is less than 6.0%.
the brushed cut edge extends over the entire length of the laser cut edge.
the brushed cut edge extends over only part of the laser cut edge.
The product of the linear energy of the laser used for the laser cutting operation by the oxygen content in volume % of the assist gas is greater than or equal to 0.03 kJ/cm.

The present invention also relates to a method for manufacturing a welded blank, comprising the steps of:
producing a first and a second precoated steel blank, at least one among the first and the second precoated steel blanks being produced using the method described above to form a laser cut edge or a brushed cut edge on at least one of the precoated steel blanks;
butt welding a weld edge of the first precoated steel blank to a weld edge of the second precoated steel blank so as to create a weld joint between said precoated steel blanks and thus obtain a welded blank, whereby the butt welding step includes a step of arranging the first and second precoated steel blanks in such a manner that the laser cut edge of at least one of the precoated steel blanks is a weld edge.

According to other optional features of the invention, considered alone or according to any possible technical combination:
the welding operation is a laser welding operation.
prior to the butt-welding step, there is a step of removing, for at least one of the first and second precoated steel blanks, the metallic layer in a removal zone adjacent to the weld edge of said precoated steel blank.
The removal of the metallic layer is performed using a laser beam.
During the removal step, the intermetallic alloy layer is left in the removal zone over at least a portion of its height.
The laser welding is performed using a filler wire or powder addition.
The filler wire or powder contains austenite-forming alloying elements.

The present invention also relates to a method for manufacturing a press-hardened steel part comprising the successive steps of:
carrying out the method described above in order to obtain a welded blank;
heating said welded blank so as to obtain an at least partly austenitic structure said welded blank;
hot forming the welded blank in a press to obtain a press-formed steel part; and
cooling the steel part in the press so as to obtain the press-hardened steel part.

According to other optional features of the invention, considered alone or according to any possible technical combination:
the cooling rate is equal to or greater than the critical martensitic or bainitic cooling rate of the steel blanks.

The present invention also relates to a precoated steel blank comprising:
a steel substrate portion having, on at least one of its faces, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blank being comprised between 0.5 mm and 5 mm, and
at least one laser cut edge surface extending between the faces of the precoated steel blank and comprising a substrate region and at least one precoating region,
   wherein the substrate region of the laser cut edge has an oxygen content in weight greater than or equal to 15% and an aluminum content in weight less than or equal to 6.0%.

The present invention also relates to a precoated steel blank comprising:
a steel substrate portion having, on at least one of its faces, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blank being comprised between 0.5 mm and 5 mm, and
at least one brushed cut edge surface extending between the faces of the precoated steel blank and comprising a brushed substrate region and at least one brushed precoating region,
wherein the oxygen content in weight of the brushed substrate region is greater than or equal to 0.5% and the aluminum content in weight of the brushed substrate region is less than 6.0%.

The present invention also relates to a welded blank comprising at least:
a first and second precoated steel blank, each precoated steel blank comprising a steel substrate portion having, on at least one of its faces, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blanks being comprised between 0.5 mm and 5 mm
a welded zone joining said first and second precoated steel blank, wherein the aluminum content in weight of the welded zone is less than or equal to 0.3% and wherein the welded zone contains at least 0.2% in volume of Aluminum oxide particles having a diameter less than or equal to 2 micrometers.

According to other optional features:
the welded zone contains at least 0.4% in volume of Aluminum oxide particles having a diameter less than or equal to 2 micrometers.

The present invention also related to a press hardened part made by press hardening a welded blank according to the above described method.

### BRIEF DESCRIPTION FO THE DRAWINGS

Other aspects and advantages of the invention will appear upon reading the following description, given by way of example, and made in reference to the appended drawings, wherein:

FIG. 1 is a schematic cross-sectional view of a precoated steel strip, taken perpendicular to the longitudinal direction of the strip;

FIG. 2 is a schematic perspective view of a precoated steel blank;

FIG. 3 is a schematic side view of the precoated steel blank of FIG. 2;

FIG. 4 is a schematic side view of a precoated steel blank on which a brushing operation was performed after the laser cutting step;

FIG. 5 is a schematic perspective view of a precoated steel blank comprising a removal zone;

FIGS. 6A and 6B are cross section observations of the laser cut edge of a pre-coated steel blank according to the invention taken after the laser cutting operation and before any further treatment of the steel blank. FIG. 6A shows the aluminum mapping on the laser cut edge surface, FIG. 6B shows the oxygen mapping on the laser cut edge surface;

FIGS. 7A and 7B are cross section observations of the brushed cut edge of a pre-coated steel blank according to the invention after it has been brushed. FIG. 7A shows the aluminum mapping on the laser cut edge surface, FIG. 7B shows the oxygen mapping on the laser cut edge surface;

FIG. 8 is a cross section observation of a welded blank according to the invention, which includes the weld joint and the two pre-coated steel blanks, showing the hardness evolution across the weld joint;

FIG. 9 is a cross section observation with aluminum mapping of the weld joint of a welded blank in which the laser cut edge surface of each of the pre-coated steel blanks was not brushed between the laser cutting step and the welding step;

FIG. 10 is a cross section observation with aluminum mapping of the weld joint of a welded blank according to the invention in which the laser cut edge surface of each of the pre-coated steel blanks was brushed between the laser cutting step and the welding step;

FIG. 11 is a plot of the aluminum content in weight of the laser cut edge in the case when no brushing is performed after laser cutting; and

FIG. 12 is a plot of the aluminum content in weight of the brushed cut edge in the case when brushing is performed after laser cutting.

### DETAILED DESCRIPTION

The invention relates to a method for producing a precoated steel blank 1.

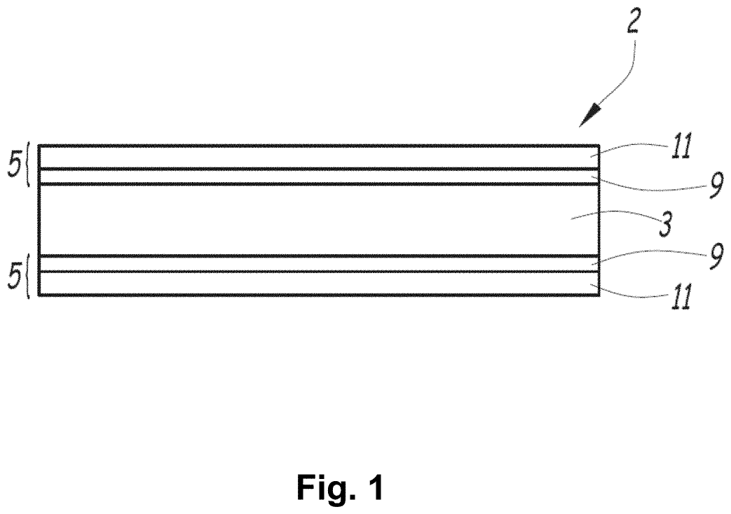

The method comprises a first step of providing a precoated steel strip 2, as shown in cross-section in FIG. 1.

As shown in FIG. 1, the precoated steel strip 2 comprises a metallic substrate 3 having, on at least one of its faces, a precoating 5. The precoating 5 is superimposed on the substrate 3 and in contact therewith.

The metallic substrate 3 is more particularly a steel substrate.

The steel of the substrate 3 is more particularly a steel having a ferrito-perlitic microstructure.

The substrate 3 is advantageously made of a steel intended for thermal treatment, more particularly a press-hardenable steel, and for example a manganese-boron steel, such as a 22MnB5 type steel.

According to one embodiment, the steel of the substrate 3 comprises, by weight:

### ≤0.10%≤C≤0.5%

### ≤0.5%≤Mn≤3%

### ≤0.1%≤Si≤1%

### ≤0.01%≤Cr≤1%

### Ti≤0.2%

### Al≤0.1%

### S≤0.05%

### P≤0.1%

### B≤0.010%

the rest being iron and impurities resulting from manufacturing.
More particularly, the steel of the substrate 3 comprises, by weight:

### 0.15%≤C≤0.25%

### 0.8%≤Mn≤1.8%

### 0.1%≤Si≤0.35%

### 0.01%≤Cr≤0.5%

### Ti≤0.1%

### Al≤0.1%

### S≤0.05%

### P≤0.1%

### B≤0.005%

the rest being iron and impurities resulting from manufacturing.
According to an alternative, the steel of the substrate 3 comprises, by weight:

### 0.040%≤C≤0.100%

### 0.80%≤Mn≤2.00%

### Si≤0.30%

### S≤0.005%

### P≤0.030%

### 0.010% Al≤0.070%

### 0.015%≤Nb≤0.100%

### Ti≤0.080%

### N≤0.009%

### Cu≤0.100%

### Ni≤0.100%

### Cr≤0.100%

### Mo≤0.100%

### Ca≤0.006%,

the rest being iron and impurities resulting from manufacturing.

According to an alternative, the steel of the substrate 3 comprises, by weight:

### 0.24%≤C≤0.38%

### 0.40%≤Mn≤3%

### 0.10%≤Si≤0.70%

### 0.015% Al≤0.070%

### 0%≤Cr≤2%

### 0.25%≤Ni≤2%

### 0.015%≤Ti≤0.10%

### 0%≤Nb≤0.060%

### 0.0005%≤B≤0.0040%

### 0.003% N≤0.010%

### 0.0001% S≤0.005%

### 0.0001%≤P≤0.025%

wherein the titanium and nitrogen contents satisfy the following relationship:

Ti/N>3.42,

and the carbon, manganese, chromium and silicon contents satisfy the following relationship:

$$2.6 C + \frac{Mn}{5.3} + \frac{Cr}{13} + \frac{Si}{15} \geq 1.1 \% ,$$

the steel optionally comprising one or more of the following elements:

### 0.05% Mo≤0.65%

### 0.001%≤W≤0.30%%

### 0.0005%≤Ca≤0.005%

the rest being iron and impurities inevitably resulting from manufacturing.

The substrate 3 may be obtained, depending on its desired thickness, by hot rolling and/or by cold-rolling followed by annealing, or by any other appropriate method.

The substrate 3 typically has a thickness comprised between 0.5 mm and 5 mm.

The precoating 5 is obtained by hot-dip coating, i.e. by immersion of the substrate 3 into a bath of molten metal. It comprises an intermetallic alloy layer 9 in contact with the substrate 3 and a metallic layer 11 extending atop the intermetallic alloy layer 9.

The intermetallic alloy layer 9 is formed by reaction between the substrate 3 and the molten metal of the bath. It comprises an intermetallic compound comprising at least one element from the metallic layer 11 and at least one element from the substrate 3.

The thickness of the intermetallic alloy layer 9 is generally of the order of a few micrometers. In particular, its mean thickness is typically comprised between 2 and 7 micrometers.

The metallic layer 11 has a composition which is close to that of the molten metal in the bath. It is formed by the molten metal carried away by the strip as it travels through the molten metal bath during hot-dip coating.

The metallic layer 11 has, for example, a thickness comprised between 19 μm and 33 μm or between 10 μm and 20 μm.

The metallic layer 11 is a layer of aluminum, or a layer of aluminum alloy or a layer of aluminum-based alloy.

In this context, an aluminum alloy refers to an alloy comprising more than 50% by weight of aluminum. An aluminum-based alloy is an alloy in which aluminum is the main element, by weight.

The intermetallic alloy layer 9 comprises intermetallic compounds of the Fex-Aly type, and more particularly Fe2Al5.

The particular structure of the precoating 5 obtained by hot-dip coating is in particular disclosed in patent EP 2 007 545.

According to one embodiment, the metallic layer 11 is a layer of aluminum alloy further comprising silicon.

According to one example, the metallic layer 11 comprises, by weight:
8%≤Si≤11%,
2%≤Fe≤4%,
   the rest being aluminum and possible impurities.

Advantageously, and as illustrated in FIG. 1, the substrate 3 is provided with a precoating 5 as described above on both of its faces.

The method for producing the precoated steel blank 1 further comprises a step of cutting said precoated steel strip 2 through laser cutting so as to obtain at least one precoated steel blank 1.

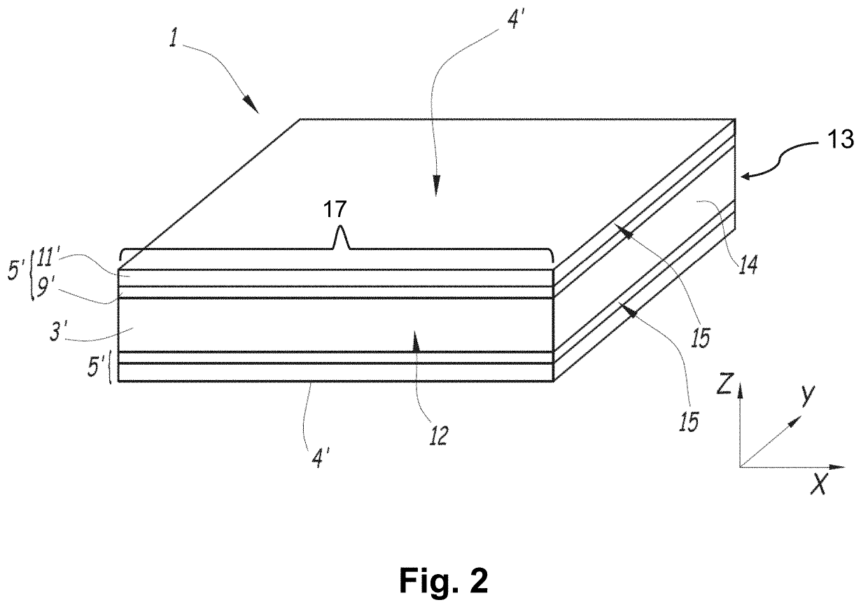

FIG. 2 is a perspective schematic drawing of such a precoated steel blank 1.

The precoated steel blank 1 comprises a substrate portion 3′ and at least one precoating portion 5′, the precoating portion 5′ including an intermetallic alloy layer portion 9′ and a metallic layer portion 11′.

The precoated steel blank 1 further comprises two main opposite faces 4′ and a peripheral edge 12 extending between the faces 4′ around the periphery of the blank 1. The length of the peripheral edge 12 is equal to the perimeter of the blank 1. The height h of the peripheral edge 12 is equal to the thickness of the blank 1.

In the context of this patent application, the height of an element is the dimension of this element taken along the direction of the thickness of the precoated blank 1 (z direction in the figures).

The peripheral edge 12 extends substantially perpendicular to the faces 4′. In this context, “substantially” means that the peripheral edge 12 extends at an angle comprised between 50° and 90° relative to one of the faces 4′. The angle of the peripheral edge 12 relative to the faces 4′ may vary along the periphery of the blank 1.

In the example shown in FIG. 2, the peripheral edge 12 has a substantially rectangular contour comprising four rectilinear sides. However, any other contour may be used, depending on the application.

The peripheral edge 12 comprises a laser cut edge surface 13 resulting from the laser cutting operation.

The laser cut edge surface 13 extends between the faces 4′ of the precoated steel blank 1 from one face 4′ to the other. It extends over the entire height h of the peripheral edge 12.

Advantageously, the precoated steel blank 1 is obtained by laser cutting along its entire contour. In this case, the peripheral edge 12 consists of the laser cut edge surface 13. The laser cut edge surface 13 thus extends around the entire periphery of the blank 1. According to an alternative, the cut edge surface 13 extends only over a fraction of the length of the peripheral edge 12. In this case, the rest of the peripheral edge 12 may coincide with the original lateral edges of the strip 2.

In the context of this patent application, the length of an element is the dimension of this element in the plane of a given face 4′ of the precoated steel strip 2. The length of the laser cut edge surface 13 therefore in particular corresponds to the dimension of the laser cut edge surface 13 along the path of the laser beam during laser cutting.

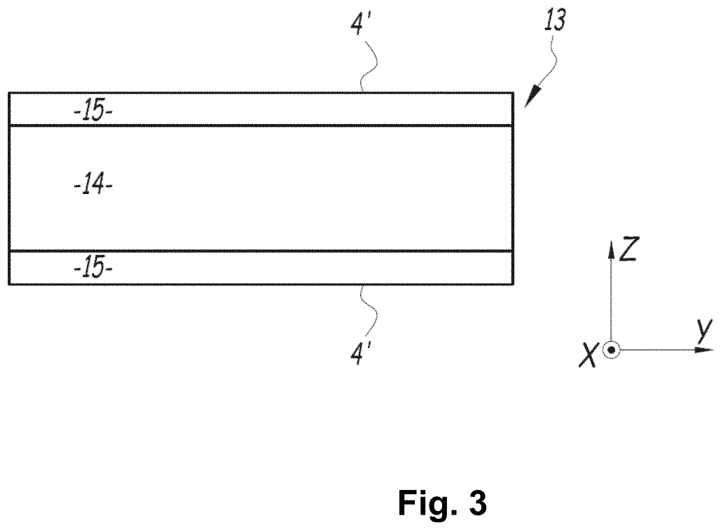

As can be seen in FIGS. 2 and 3, the laser cut edge surface 13 comprises a substrate portion 14 and at least one precoating portion 15. The substrate portion 14 corresponds to the surface of the substrate 3′ located at the laser cut edge surface 13. The precoating portion 15 corresponds to the surface of the precoating 5′ located at the laser cut edge surface 13. It consists essentially of the material of the precoating 5′.

The thickness of the precoated steel blank 1 is identical to that of the precoated steel strip 2. It is comprised between 1.0 mm and 5 mm, more particularly comprised between 1.0 mm and 3.0 mm, more particularly between 1.0 mm and 2.5 mm, and even more particularly between 1.2 and 2.5 mm.

During the laser cutting step, a laser beam of a laser cutting device is applied to the steel strip 2 along a predetermined path so as to obtain the laser cut edge surface 13. This predetermined path extends in the plane of a face 4′ of the blank 1.

In a particular embodiment, the laser used for the laser cutting is advantageously a continuous laser.

According to the invention, the substrate portion 14 of the laser cut edge 13 shows a weight content of oxygen greater than 15%.

It should be noted that the weight content of oxygen on the edge is defined as the weight content as measured by the conventional measurement of using an Energy Dispersive Spectroscopy detector integrated on a Scanning Electron Microscope. Such a measurement technique typically measures the concentration of elements up to a depth of approximately 1 micrometer below the surface. The same definition is used for the aluminum content on the edge in the subsequent description.

In this context, “directly resulting” in particular means that the fraction or ratio of aluminum is measured immediately after the laser beam of the laser cutting device has cut the precoated steel blank 1 from the precoated steel strip 2, and in particular before any further step is carried out on the cut edge surface 13 of the precoated steel blank 1, for example before a possible finishing step of the cut edge surface 13, such as brushing, machining, milling, sandblasting or stripping.

In a particular embodiment, the aluminum content in weight % of the substrate portion 14 of the laser cut edge 13 is less than or equal to 6.0%.

Advantageously, the laser cut edge surface 13 extends over a length equal to at least 3 mm, and more particularly over at least 10 mm.

For example, in the example shown in FIG. 2, in which the precoated steel blank 1 has a rectangular contour, the laser cut edge surface 13 extends over one or more sides of the rectangle.

The laser cutting is carried out using an assist gas containing at least 10% in absolute volume of oxygen. For example, the laser cutting is performed using air as assist gas, which contains between 19% and 21% in weight of oxygen, the balance being mainly Nitrogen. For example, the laser cutting is performed using pure oxygen as assist gas. Advantageously, by using an oxygen containing assist gas, it is possible to increase the productivity of the laser cutting operation, compared to a laser cutting process in which an inert gas such as pure nitrogen or argon, is used as assist gas. This is thanks to the exothermic reaction taking place between oxygen and iron as well as possibly between oxygen and aluminum.

It should be noted that in the current context, pure oxygen is defined as being a gas having an oxygen content above 99% in absolute volume.

During the cutting operation, the aluminum contained in the precoating 5 of the strip 2 is heated and melted by the heat generated by the laser. As a result, the molten metallic aluminum has a tendency to flow on to the laser cut edge 13, thereby polluting the laser cut edge 13 with aluminum, which is potentially detrimental to the subsequent strength of the weld in the case where the laser cut edge 13 is incorporated in the weld joint, as was previously explained.

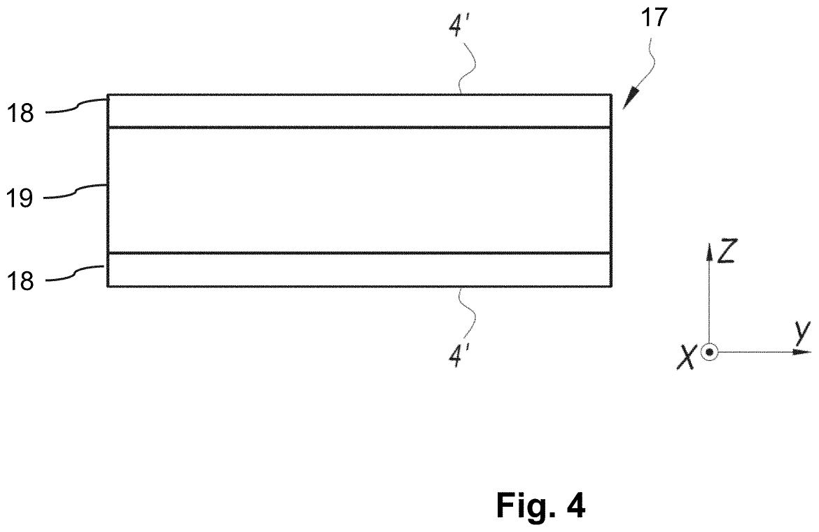

According to an embodiment, as depicted in FIG. 4, a brushing operation is performed after the laser cutting operation on at least part of the laser cut edge 13 to form a brushed cut edge 17. For example, the brushing operation can be performed using the following parameters:
brush rotation speed: 1180 rpm
Brush reference: Novofil® NH-S 80

Said brushed cut edge 17 comprises a brushed substrate portion 18 and at least one brushed precoating portion 19. For example, in the case when the precoated steel blank 1 has a rectangular contour, the brushed cut edge 17 may extend over only some of the sides of the rectangle, and for example over only one side of the rectangle.

According to an embodiment, the brushed cut edge 17 extends over the entire length of the laser cut edge 13, in which case the length of the brushed cut edge 17 is equal to the length of the laser cut edge 13.

The aim of the brushing operation is to remove the pollution deposited on the laser cut edge 13 and resulting directly from the laser cutting operation. In particular, the aim of the brushing operation is to remove the aluminum pollution on the laser cut edge 13 resulting from the laser cutting operation.

According to an embodiment, the content of aluminum in weight of the brushed substrate portion 18 is less than 6.0%. Thanks to the brushing operation, the aluminum pollution present on the edges and resulting from the laser cutting operation can be at least partially removed. Surprisingly, the inventors have found that when using an assist gas containing at least 10% of oxygen in volume, it is easier to remove the aluminum pollution from the laser cut edge 13 by brushing than when the laser cutting operation is performed using an inert gas as an assist gas.

While not wishing to be bound by any theory, it is possible that the use of a significant amount of oxygen within the assist gas leads to the formation of aluminum oxides on the laser cut edge 13, said aluminum oxides having a lower adhesion to the edge than the metallic aluminum, which would have been present on the edge as a result of cutting under inert gas, a process in which the molten aluminum resulting from the heat generated by the cutting operation is not exposed to oxygen and therefore stays in metallic unoxidized or only slightly oxidized form. As a result of the lower adhesion of oxidized aluminum on the laser cut edge 13, the brushing operation is more efficient in the case of a precoated steel blank 1 obtained by laser cutting according to the present invention.

The inventors have also observed that the laser cut edge 13 resulting from the laser cutting operation according to the current invention presents a distinct visual aspect, different from that of a laser cut precoated steel blank in which an inert gas is used as assist gas. In particular, the laser cut edge 13 has a blueish or even dark hue resulting from the presence of oxidized metallic particles such as oxidized aluminum coming from the precoating 5 of the steel strip 2 and oxidized iron as well as other oxidized metallic elements such as for example manganese, coming from the substrate 3 of the steel strip 2. This particular visual aspect could be construed by the casual observer as an indicator of poor quality, which would deter from applying the described process of the current invention to obtain good quality precoated steel blanks 1. However, as explained previously, laser cutting using an assist gas containing upward of 10% of oxygen in volume to produce a laser cut edge 13 having a substrate region 14, which contains at least 15% of oxygen in weight actually allows to brush the laser cut edge 13 efficiently in order to form a brushed cut edge 17 having a low content of aluminum.

The inventors have also observed that the laser cut edge 13 obtained by applying the current invention surprisingly has a better corrosion resistance than a laser cut edge obtained through a laser cutting process using an inert assist gas. Precoated steel blanks that were produced according to the invention were placed in a cataplasm having 100% humidity and maintained at a temperature of 70° C. Precoated steel blanks that were laser cut using pure nitrogen as assist gas were placed in the same cataplasm as reference pre-coated steel blanks. A first set of pre-coated steel blanks was taken out of the cataplasm after 96 hours and the aspect of the laser cut edges was observed. No red rust was found on the laser cut edge of the pre-coated steel blanks that had been produced according to the invention, whereas red rust was observed on the laser cut edge of the reference pre-coated steel blanks. A second set of pre-coated steel blanks was taken out of the cataplasm after 1 week and the aspect of the laser cut edges was observed. No red rust was found on the laser cut edge of the pre-coated steel blanks that had been produced according to the invention, whereas red rust was observed on the laser cut edge of the reference pre-coated steel blanks.

While not wishing to be bound by any theory, it is possible that the presence of the above described metallic oxides on the laser cut edge 13 form a barrier to atmospheric corrosion. The observed improved corrosion resistance presents a significant industrial advantage because the precoated steel blank 1 can thus be stored without taking costly measures to prevent the formation of rust on the edges before it is used to form a laser welded blank.

According to an embodiment, the amount of oxygen in weight on the brushed cut edge 17 is above 0.5%. Indeed, the brushing operation is able to remove a part of the aluminum pollution and also a part of the oxides present at the surface of the laser cut edge 13. However, the inventors have found that a significant portion of oxygen inherited from the laser cutting process according to the present invention is still visible at the surface after the brushing operation has been performed. It should be noted that the oxygen content measurement on the edge is preferably performed right after the brushing step and before storing the pre-coated steel blank. Indeed, during storage the oxygen present in the air will oxidize the edge and therefore increase the measured oxygen content of the edge.

The inventors have further observed that the brushing operation applied on at least part of the laser cut edge 13 has a further beneficial effect of removing part or all of the burr resulting from the laser cutting operation, on top of the above described effect of lowering the aluminum edge pollution. Indeed, the cutting operation using an oxygen rich assist gas will lead more frequently to the formation of a burr at the bottom of the laser cut edge 13, as compared to laser cutting with an inert assist gas. This burr is easily detachable from the laser cut edge 13 and can be mostly removed by a brushing operation.

According to an embodiment, the laser cut edge 13 forms at least an edge of the precoated steel blank 1 intended to be welded to another precoated steel blank 1. In this case, at least part of the laser cut edge 13 is intended to be incorporated in the weld joint. In this embodiment, the laser cut edge 13 is used as is as the weld edge, without subsequent brushing operation.

According to an embodiment, the brushed cut edge 17 forms at least an edge of the precoated steel blank 1 intended to be welded to another precoated steel blank 1. In this case, at least part of the brushed cut edge 17 is intended to be incorporated in the weld joint.

According to an embodiment, the brushed cut edge 17 extends only over the edge of the precoated steel blank 1 intended to be welded to another precoated steel blank 1. Advantageously this allows to optimize the productivity of the production process of the precoated steel blank 1. Indeed, the brushing operation has a cost which is linked to the length of the laser cut edge 13 to be brushed. By limiting this length to the portion of the laser cut edge 13 which is intended to be welded, the brushing operation will be performed only where it actually brings a benefit to the final quality of the welded blank, through the diminution of the aluminum pollution and the overall improvement of edge quality.

Turning to the laser cutting parameters, the inventors have found that a specific combination of linear energy and oxygen content of the assist gas can yield advantageous results. The laser cutting linear energy corresponds to the amount of energy sent by the laser beam during laser cutting per unit length. It can be calculated by dividing the power of the laser beam by the cutting speed. The inventors have found that the process window to obtain a satisfying amount of aluminum on the edge after laser cutting can be defined by using a compound parameter of the linear energy and the amount of oxygen in the assist gas. This parameter is the product of the linear energy by the oxygen content of the assist gas. Because the oxygen of the assist gas plays a role in the energy balance of the cutting operation thanks to the exothermic oxidation of iron and possibly of aluminum, it can be understood that the amount of oxygen contained in the assist gas multiplied by the linear energy of the laser measures a form of cutting energy and therefore can be used to define a process window.

Laser cutting may be advantageously performed using a linear energy and an assist gas selected in such a way that the product of the linear energy of the laser used for the laser cutting operation by the oxygen content in volume % of the assist gas is greater than or equal to 0.09 kJ/cm. As will be illustrated in table 1 of the examples described here below, this minimum value enables to consistently obtain a laser cut edge 13 having a substrate portion 14 with an oxygen content in weight % greater than or equal to 15% and an aluminum content in weight % less than or equal to 6.0%.

Laser cutting may be advantageously performed using a linear energy and an assist gas selected in such a way that the product of the linear energy of the laser used for the laser cutting operation by the oxygen content in volume % of the assist gas is greater than or equal to 0.03 kJ/cm. As will be illustrated in table 1 of the examples described here below, this minimum value enables to consistently obtain a brushed cut edge 17 having a substrate portion with an oxygen content in weight % greater than or equal to 0.5% and an aluminum content in weight % less than or equal to 6.0%.

In other words, the brushing operation can be used to widen the process window of the laser cutting operation by lowering the minimum of the above defined compound parameter from 0.09 kJ/cm to 0.03 kJ/cm while keeping an acceptable level of aluminum on the edge (below 6.0% in weight).

According to one embodiment, the laser cutting step is carried out using a CO2 laser. The CO2 laser is advantageously a continuous laser.

The CO2 laser for example has a power comprised between 2 kW and 10 kW.

According to another embodiment, the laser cutting step is carried out using a solid-state laser. The solid state laser is for example an Nd:YAG (neodymium-doped yttrium aluminium garnet) laser, a fiber laser, a diode laser or a disk laser.

The solid-state laser for example has a power comprised between 2 kW and 20 kW.

The invention also relates to a precoated steel blank 1, which may be obtained using the method disclosed above. This precoated steel blank 1 has been described above with reference to FIGS. 2, 3 and 4.

The precoated steel blank 1 has a weight content of oxygen in the substrate region 14 which is above 15%.

In a particular embodiment, the precoated steel blank 1 has a weight content of aluminum in the brushed substrate region which is below 6.0% and a surface fraction of oxygen in the brushed substrate region which is above 0.5%.

Furthermore, the precoated steel blank 1 comprises a heat affected zone at the cut edge surface 13. This heat affected zone results from the heating of the cut edge surface 13 during laser cutting. It may be observed through conventional means for detecting the presence of a heat affected zone, for example through micro- or nano-hardness measurements or through metallographic observations after adapted etching.

The invention also relates to a method for manufacturing a welded blank, comprising the steps of:
producing a first and a second precoated steel blank 1, at least one among the first and the second precoated steel blanks 1, and preferably the first and the second precoated steel blanks 1, being produced using the method as disclosed above;
butt welding the first and the second precoated steel blanks 1 in order to create a weld joint between said steel blanks 1 and obtain a welded blank.

The butt-welding step includes a step of arranging the first and second precoated steel blanks 1 in such a manner that the laser cut edge 13 of at least one of the precoated steel blanks 1 faces an edge of the other precoated steel blank 1.

In a particular embodiment, the butt-welding step includes a step of arranging the first and second precoated steel blanks 1 in such a manner that the brushed cut edge 17 of at least one of the precoated steel blanks 1 faces an edge of the other precoated steel blank 1.

The weld joint between said first and second precoated steel blanks 1 is obtained from the melting of their facing edges, and in particular from at least one of a laser cut edge 13. In a particular embodiment, the weld joint is obtained from the melting of at least one of the brushed cut edge 17 of at least one of the precoated steel blanks 1.

The welding is advantageously a laser welding.

The welding may be an autogenous welding, i.e. without adding a filler material, for example in the form of a wire or a powder.

According to an alternative, the welding is carried out using an adequate filler material, for example a filler wire or powder. The filler wire or powder can in particular include austenite-forming elements so as to balance the ferrite-forming and/or the intermetallic compound forming effect of the aluminum pollution coming from the precoating.

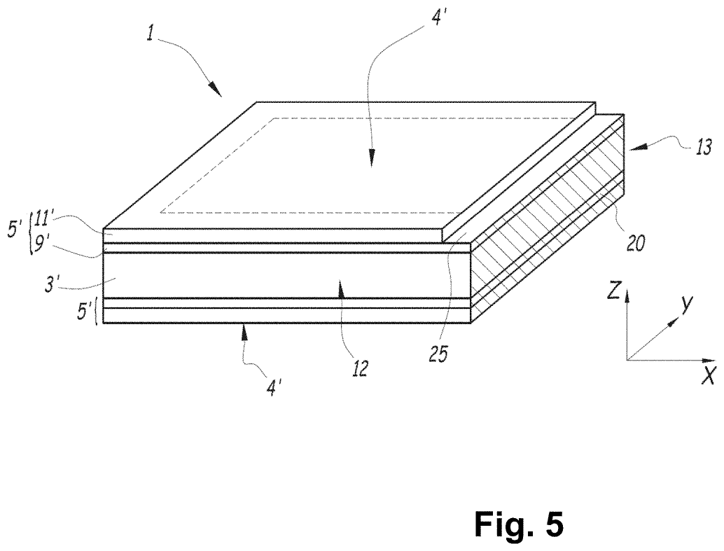

Advantageously, as shown in FIG. 5, prior to butt welding, for at least one of the precoated steel blanks 1, the metallic layer 11′ is removed on at least one face 4′ of the precoated steel blank 1 over a removal zone 25 that is adjacent to the laser cut edge 13 of the considered precoated steel blank 1 and, during the butt welding step, the precoated steel blanks 1 are welded along at least the one edge from which the metallic layer 11′ has been removed. Preferably, the metallic layer 11′ is removed from each of the first and second precoated steel blank 1 prior to butt welding.

The removal of the metallic layer 11′ is advantageously carried out through laser ablation as disclosed in prior application WO 2007/118939.

The width of the removal zone 25 on each of the steel blanks 1 is for example comprised between 0.2 and 2.2 mm.

Preferably, the removal step is carried out so as to remove only the metallic layer 11′ while leaving the intermetallic alloy layer 9′, as shown in FIG. 5. Therefore, the intermetallic alloy layer 9′ is left in the removal zone over at least a portion of its height. In this case, the residual intermetallic alloy layer 9′ protects the areas of the welded blank immediately adjacent to the weld joint from oxidation and decarburization during subsequent hot-forming steps, and from corrosion during in-use service of the hot-formed steel part.

Optionally, the method for manufacturing a welded blank comprises a step of brushing the edge of the precoated steel blank 1 that is to be welded of at least one among the first and the second precoated steel blanks 1, and preferably both the first and the second precoated steel blanks 1, prior to carrying out the welding step.

If the method includes the removal of the metallic layer 11′ prior to welding, brushing is preferably carried out after this removal step. In this case, the brushing removes the aluminum traces that may have spattered, during the removal operation, onto the edge of the blank 1 that is to be welded. Such a spattering may in particular occur when the removal is performed through laser ablation. Such spatter has a relatively low adherence to the edge and can therefore be removed relatively easily through brushing. Brushing may therefore further reduce the aluminum content in the weld joint.

The inventors have found that by applying the current invention, the laser welded blanks that are formed using precoated steel blanks 1 for which both edges to be welded are a laser cut edge 13, on which no brushing operation was performed prior to welding, the weld joint has an aluminum content which is below 0.3% in weight and presents a characteristic inclusion population of aluminum oxides having a diameter below 4 micrometers and covering at least 0.4% in volume of the weld joint.

In the current context, the diameter of a particle is defined as being the diameter of the smallest possible sphere in which said particle can be encapsulated.

The inventors have found that by applying the current invention, the laser welded blanks that are formed using precoated steel blanks 1 for which both edges to be welded are a brushed laser cut edge 17, the weld joint has an aluminum content which is below 0.3% in weight and presents a characteristic inclusion population of aluminum oxides having a diameter below 2 micrometers and covering at least 0.2% in volume of the weld joint.

Surprisingly, the inventors have found that despite the presence of oxygen on the edges before welding, resulting from the presence of oxygen in the assist gas, and despite the presence of aluminum oxides in the weld joint, said weld joint exhibited good mechanical strength and toughness as will be subsequently described in an example. It is known in the literature that the presence of oxygen in a weld joint, and in particular the presence of aluminum oxides, can negatively effect the plasticity and the toughness of said weld joint.

The invention also relates to a method for manufacturing a press-hardened steel part comprising the steps of:
producing a welded blank using the method as disclosed above;
heating the welded blank so as to obtain an at least partly austenitic structure in the steel blanks 1 forming the welded blank;
hot forming the welded blank in a press so as to obtain a press-formed steel part; and
cooling the steel part in the press so as to obtain the press-hardened steel part.

More particularly, the welded blank is heated to a temperature that is greater than the upper austenite transformation temperature Ac3 of the steel blanks 1.

During the cooling step, the cooling rate is advantageously equal to or greater than the critical martensitic or bainitic cooling rate of the steel blanks.

Because the above-mentioned aluminum oxides inclusions in the weld joint are stable at the temperatures used for heating the laser welded blank before hot forming, the resulting press-hardened steel part will retain the same aluminum oxides inclusion in the location where the weld joint was present on the original laser welded blank before the press-forming operation. Said location of the weld joint within the press hardened steel part is a volume that comprises at least a part of the surface of each face of said press-hardened steel part and which extends between at least two edges of said press-hardened steel part.

More particularly, in the case of a press-hardened steel part which was formed from a laser welded blank using precoated steel blanks 1 for which both edges to be welded are a laser cut edge 13, on which no brushing operation was performed prior to welding, the location at which the weld joint of the laser welded blank was originally present, has a characteristic inclusion population of aluminum oxides having a diameter below 4 micrometers and covering at least 0.4% in volume.

In the case of a press-hardened steel part which was formed from a laser welded blank using precoated steel blanks 1 for which both edges to be welded are a brushed laser cut edge 17, the location at which the weld joint of the laser welded blank was originally present, has a characteristic inclusion population of aluminum oxides having a diameter below 4 micrometers and covering at least 0.2% in volume of the weld joint.

The inventors of the present invention have carried out the following experiments. A first set of experiments is focused on analyzing the laser cut edge 13 and the brushed cut edge 17 of a precoated steel blank according to the invention. A second set of experiments is focused on analyzing a press hardened steel part according to the invention.

In a first set of experiments, precoated steel blanks 1 were cut from precoated steel strips 2 through laser cutting using a CO2 laser with pure oxygen and air as an assist gas and using different laser cutting speeds and energies. The precoated steel blanks 1 had a rectangular shape. Steel strips 2 of different thicknesses were used. A part of the thus produced precoated steel strips 1 were then observed as they were, with a laser cut edge 13 which was not subsequently processed by brushing. Another part of the thus produced precoated steel strips 1 were submitted to a brushing operation to form a brushed cut edge 17 before being observed.

The precoated steel strips 2 were strips having the compositions and precoatings as disclosed above.

More particularly, the steel of the strip 2, comprised, in weight %:

### C: 0.22%

### Mn: 1.16%

### Al: 0.03%

### Si: 0.26%

### Cr: 0.17%

### B: 0.003%

### Ti: 0.035%

### S: 0.001%

### N: 0.005%

the rest being iron and possible impurities resulting from elaboration.

This steel is known under the commercial name Usibor® 1500.

The precoating 5 has been obtained by hot-dip coating the steel strip 2 in a bath of molten metal.

The metallic layer of the precoating 5 comprised, by weight:

### Si: 9%

### Fe: 3%,

the rest consisting of aluminum and possible impurities resulting from elaboration.

The metallic layer had an average total thickness of 20 μm.

The intermetallic alloy layer contained intermetallic compounds of the Fex-Aly type, and majoritarily Fe2Al3, Fe2Al5 and FexAlySiz It has an average thickness of 5 μm.

For each thus produced precoated steel blanks 1, the inventors measured the weight content of aluminum and oxygen on the substrate region 14 of the laser cut edge 13 for the samples which were not brushed and the weight content of aluminum and oxygen on the brushed substrate region 19.

The measurements were performed based on images of the considered edge surface taken with a scanning electron microscope using the following parameters:
magnification: ×60
analysis length: 3 mm;
electron beam energy: between 15 and 25 keV.

The experiments were carried out using a CO2 laser having a nominal power of 4 kW, in the experiments different power levels were used between 1.9 kW and 3.8 kW. The assist gas pressure was comprised between 3 and 15 bars. The cutting speed was comprised between 3 and 20 meters per minute. The nozzle diameter for blowing the assist gas was 0.8 mm in the case of pure oxygen and 1.4 mm in the case of air. The standoff distance separating the nozzle from the laser beam impact point was 0.7 mm. The thickness of the steel strip 2 that was used was comprised between 0.8 mm and 1.6 mm.

The brushing operation was performed using 7 brushes travelling at 10 meters per minute powered by motors applying a torque of 0.3 Newton-meter and turning at 1180 RPM. The brushes used have the commercial reference Novofil® NH-S 80.

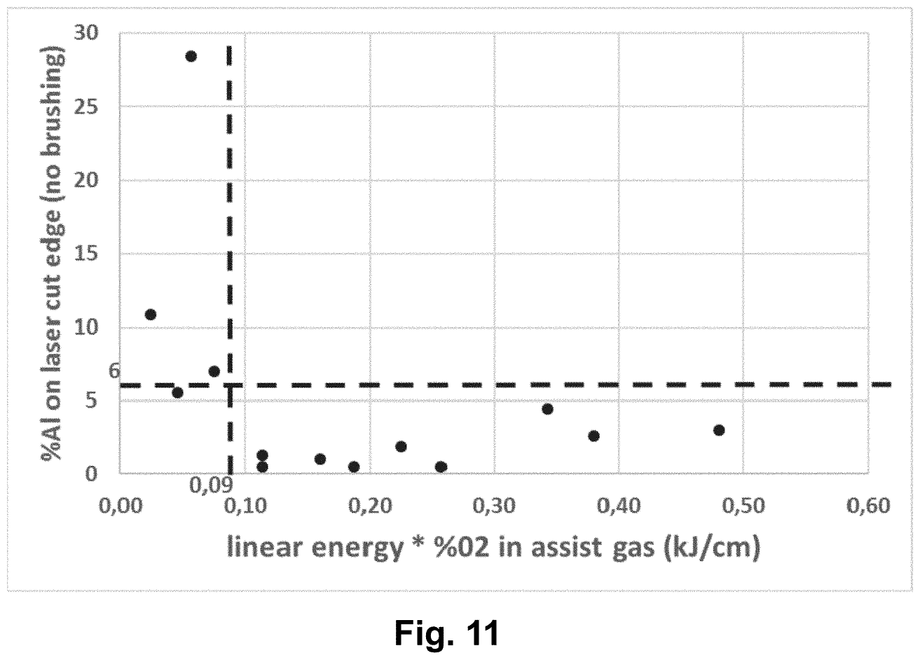

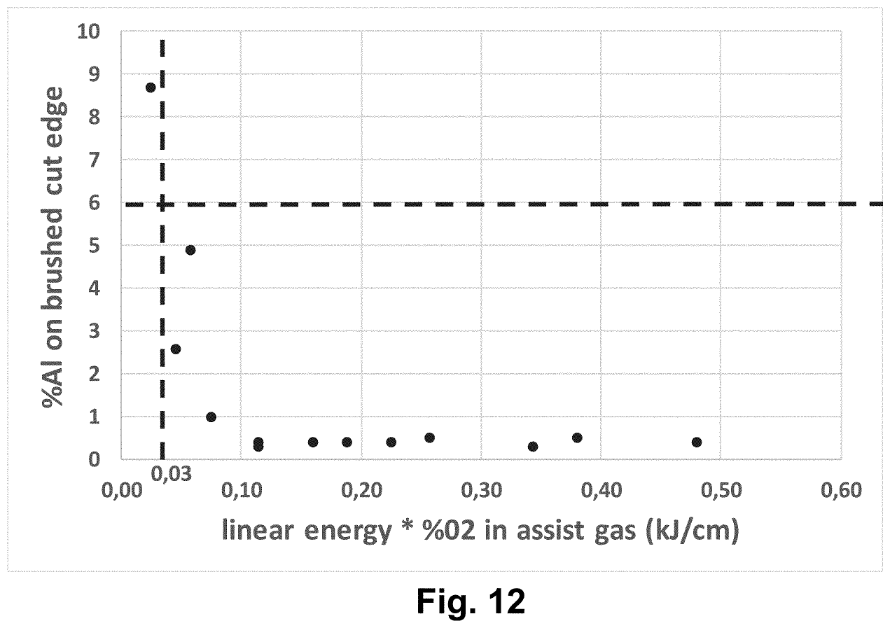

The results of the tests are reported in Table 1. The results are expressed in terms of weight content of oxygen and aluminum on the substrate region 14 of the laser cut edge 13 or on the brushed substrate portion 19 of the brushed cut edge 17 and in terms of edge quality. FIGS. 11 and 12 are a graphic representation of the results of table 1 plotting the % Al respectively on the substrate portion 14 of the laser cut edge 13 and the brushed substrate region 19 of the brushed cut edge 18 as a function of the product of the linear energy by the amount of oxygen in the assist gas.

It should be noted here that in the current context, edge quality is classified in one of the three following categories: very good, small burr, strong burr. By very good, it is meant that no burr was observed on the bottom of the laser cut edge 13 or the brushed cut edge 17. By small burr, it is meant that the height of the burr resulting from the laser cutting process is strictly less than 0.1 mm. By strong burr, it is meant that the height of the burr resulting from the laser cutting process is 0.1 mm or more. The presence of a burr on the edge of the precoated steel blank which is intended to be welded can lead to defects on the weld joint, which are detrimental to the mechanical strength of the weld joint.

Modalities 1 to 14 are before brushing and 1b to 14b are after brushing.

As can be seen in table 1 and FIG. 11, when the product of the linear energy by the amount of oxygen in the assist gas is greater than or equal to 0.09 kJ/cm, the amount of aluminum on the substrate region 14 is less than 6.0%.

As can be seen in table 1 and FIG. 12, when the product of the linear energy by the amount of oxygen in the assist gas is greater than or equal to 0.03 kJ/cm, the amount of aluminum on the brushed substrate region 19 is less than 6.0%.

As can be seen in table 1, the amount of oxygen on the substrate portion 14 directly resulting from the laser cutting operation is above 15% except for modality 7, which shows an oxygen content of the edge of 9%. Modality 7 was performed using a very low linear energy by % oxygen in the assist gas of 0.02 kJ/cm.

As can be seen in table 1, when using pure oxygen as assist gas, the weight content of oxygen on the substrate portion 14 of the laser cut edge 13 is always above 15%.

Table 1 also reports the edge quality of the laser cut edge 13 or the brushed cut edge 17. As can be seen, the laser cut edge 13 quality varies from very good to strong burr. The laser cut edge 13 produced according to the current invention lends itself very well to brushing in order to improve the edge quality. Indeed the edge quality after brushing is always rated as very good after the brushing operation, as can be seen on table 1.

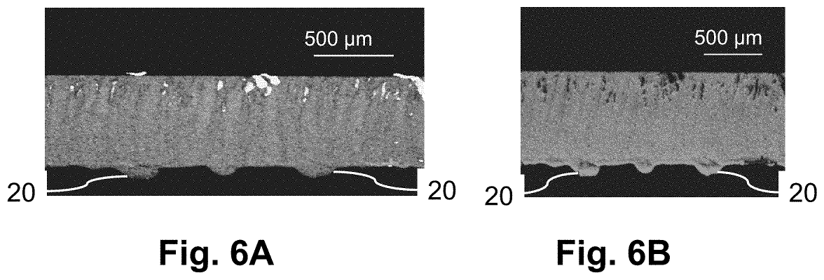

FIGS. 6A and 6B are cross section observations of the laser cut edge 13 of the pre-coated steel blank corresponding to modality 1 of table 1, i.e. having a precoated steel blank thickness of 0.8 mm, a laser power of 1.9 kW for the cutting operation, a cutting speed of 3 meters per minute and a pure oxygen gas pressure of 18 bars as assist gas. FIG. 6A shows the aluminum mapping on the laser cut edge 13 surface, the aluminum pixels appear in white on a grey background. FIG. 6B shows the oxygen mapping on the laser cut edge 13 surface, the oxygen pixels correspond to the overall grey background, while the black spots on the grey background are the non oxygen pixels. The burr 20 resulting from the laser cutting process can be seen on the bottom of the cross sections 6A and 6B.

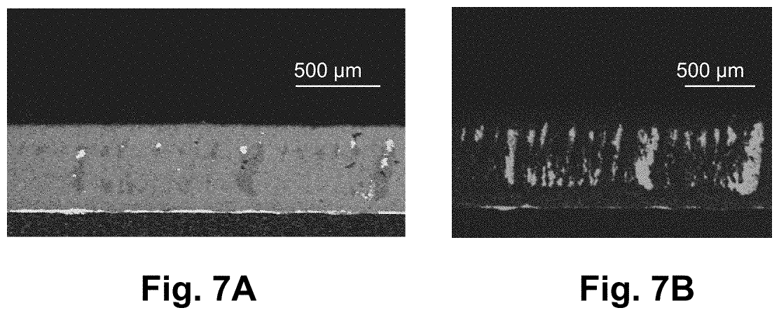

FIGS. 7A and 7B are cross section observations of the brushed cut edge 17 of the pre-coated steel blank corresponding to modality 1b of table 1. The laser cutting parameters are the same as for the above detailed modality 1, but in the case of modality 1b the laser cut edge 13 was brushed using to the above detailed brushing parameters to obtain a brushed cut edge 17. FIG. 7A shows the aluminum mapping on the brushed cut edge 17 surface, the aluminum pixels appear in white on a grey background. FIG. 7B shows the oxygen mapping on the brushed cut edge 17 surface, the oxygen pixels correspond to the grey pixels on a dark background. It can also be seen that the burr 20 observed in FIGS. 6A and 6B is not anymore present on FIGS. 7A and 7B, confirming that the brushing operation performed on a precoated steel blank according to the invention enables to remove the burr directly resulting from the cutting operation.

In a second set of experiments, press hardened steel parts produced according to the current invention were analyzed. In a first step, precoated steel blanks 1 were produced according to the invention.

The precoated steel blanks 1 were produced from precoated strips having a thickness of 0.8 mm and 1.6 mm and having the same chemical composition as detailed above for the first set of experiments. The laser cutting operation was performed using a product of linear energy by oxygen content of the assist gas above 0.09 kJ/cm in the case of non-brushed as cut precoated steel blanks and above 0.03 kJ/cm in the case of brushed precoated steel blanks.

The precoated steel blanks 1 were then submitted to a step of removing the metallic layer in a removal zone adjacent to the weld edges on both faces 4′ of the precoated steel blanks 1 using a pulsed laser and applying the following parameters:
Spot size: 0.5*2 mm
Travel speed: 2.5 m/min
Frequency: 6 kHz
Power: 450 W
Laser source: Rofin DQx 45 s

A brushing operation was performed on part of the precoated steel blanks 1. The brushing operation was performed using the following parameters: brushing with 7 brushes travelling at 10 meters per minute powered by motors applying a torque of 0.3 Newton-meter, with an RPM of 1180 and using brushes of the commercial reference Novofil® NH-S 80.

The thus prepared precoated steel blanks 1 were then laser welded, arranging the first and the second precoated steel blank 1 in such a way that the laser cut edge 13, or in the case when brushing was performed the brushed cut edge 17, are the weld edges. The laser welding was performed using a filler wire. The following laser welding parameters were used for all modalities:
Filler wire diameter: 1 mm
Collimation/Focalization: 200/200
Fiber diameter: 600 micrometers
Protection gas: Helium (flow of 15 liters per minute)

The filler wire that was used has the following composition, expressed in weight %:

0.65%≤C≤0.75%

1.95%≤Mn≤2.05%

0.35%≤Si≤0.45%

0.95%≤Cr≤1.05%

0.15%≤Ti≤0.25%

the balance being iron and unavoidable impurities from processing.

The thus produced welded blanks were then processed to form press hardened steel parts, by heating said welded blanks above the austenization temperature and then quenching them in a tool at a speed higher than the critical martensitic cooling rate of the precoated steel blanks 1.

The detailed laser welding parameters specific to each modality, as well as the results of the second set of experiments are reported in table 2.

A first set of results concerns the presence or absence of a drop in hardness within the weld metal zone as compared to the hardness of the portion of the press hardened steel part corresponding to the substrate of the precoated steel blanks. As can be seen in table 2, in all cases, whether brushing was performed or not, no drop in hardness was observed in the weld metal zone. This indicates that the weld metal zone will have a good mechanical behavior on the part and will not constitute a weak zone of the part, which could lead to premature damage of the part.

The hardness was measured using the Vickers hardness test according to the standard NF EN ISO 6507-1. The tests were performed transversely to the weld joint, using a test force of 0.5 kgf (HV0.5).

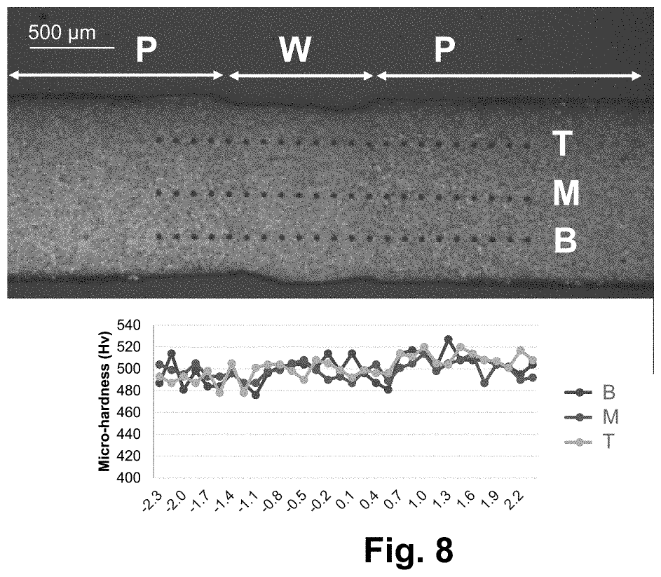

FIG. 8 depicts the hardness measurements that were performed on modality 15b, in which two precoated steel blanks, each having a thickness of 1.6 mm were prepared and welded according to the parameters detailed in table 1 and in the above description. The top part of FIG. 8 is a cross-section micrograph of the welded sample, which includes the weld in the middle, identified by the letter W, and the two pre-coated steel blanks 1 on either side of the weld, identified by the letter P. The three horizontal black dotted lines on the micro-graph correspond to the areas on which the micro-hardness tests were performed, the black dots being the traces left by the indentation performed to measure the micro-hardness. The lines are identified by the letters T, M and B, meaning Top, Middle and Bottom. The bottom part of FIG. 8 depicts the results of the micro-hardness measurements along lines T, M and B. As can be seen, there is no drop of hardness within the weld zone, as compared with the pre-coated steel blanks 1.

A second set of results concerns the amount of aluminum that was dissolved in the weld metal zone using an Energy Dispersive Spectroscopy detector integrated on a Scanning Electron Microscope.

As can be seen in table 2, the amount of aluminum dissolved in the weld zone is consistently below 0.3% in weight. Thanks to this low level of aluminum, the weld could undergo the metallurgic transformations leading to a fully martensitic micro-structure, which does not present a lower hardness as the surrounding substrates, as seen in the hardness measurements explained above.

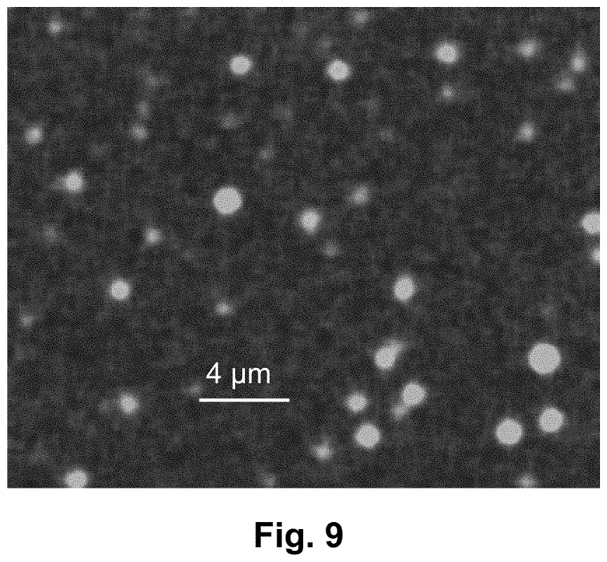

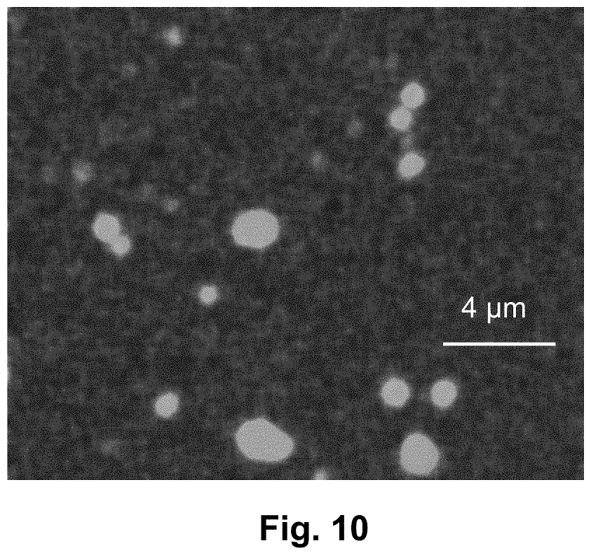

A third set of results, corresponding to observations that were done on the weld metal zone of samples of modality 15 and 15b, concerns the inclusion population of the weld metal zone, and more particularly the characterization of small aluminum oxide particles in the weld metal zone. FIGS. 9 and 10 are aluminum mappings on the cross sections of the weld metal zones corresponding respectively to modalities 15 and 15b. The pictures were taken using a scanning electron microscope set at a magnification of 10000 and using an Energy Dispersive X-Ray analysis probe set to detect aluminum and oxygen. As can be seen on FIGS. 9 and 10, the detected particles of aluminum oxides are generally spherical in shape and have a diameter which does not exceed 2 micrometers. The volumetric density of said aluminum oxides are reported in table 2. The volumetric density was measured to be on average 0.6% for modality 15 and 0.3% for modality 15b. The decrease in density between 15 and 15b is explained by the fact that some aluminum is removed from the edges by the brushing operation, leaving less aluminum to be dissolved in the weld. It should be noted that these small aluminum oxides particles are not observed on welds performed on precoated steel blanks which are cut using either mechanical cutting or laser cutting with an inert assist gas.

Without wanting to be bound by theory, the inventors suggest the following reasons to explain why the aluminum oxide particles that are observed in the weld metal zone are not detrimental to the overall mechanical strength of the weld metal zone. The first one is that the aluminum which is present in these oxides is not available to dissolve in the iron matrix of the weld metal zone and does therefore not affect the metallurgical phenomena that take place during the hot stamping process. More particularly, it does not affect the austenitization temperature, nor does it affect the quenchability of the weld metal zone. The second reason is that the aluminum oxide partices are sufficiently small not to have any significant impact on the mechanical resistance of the weld metal zone. Thanks to their small size, these particles will not represent areas of significant stress concentration, and therefore will not be the cause of micro-crack initiation that would lead to the failure of the weld.

TABLE 1

| | | | Laser cutting parameters | | | | | | | | | | |
|---|---|---|---|---|---|---|---|---|---|---|---|---|---|
| modality | | | | | | | | Cutting | | linear | | | |
| | | steel strip | | % O2 in | Gas | | Laser | Speed | linear | energy * | Cut edge characteristics | | |
| | | Thickness | | assist | Pressure | Laser | Power | (meters/ | energy | % O2 in gas | Al | O | edge |
| Modality | Brushing | (mm) | Assist Gas | gas | (bar) | Source | (kW) | minute) | (kJ/cm) | (kJ/cm) | (%) | (%) | quality |
| 1 | no | 0.8 | pure oxygen | 100% | 12 | CO2 | 1.9 | 3 | 0.38 | 0.38 | 2.6 | 23.6 | small burr |
| 2 | no | 0.8 | pure oxygen | 100% | 15 | CO2 | 3 | 8 | 0.23 | 0.23 | 1.9 | 23.7 | small burr |
| 3 | no | 1 | pure oxygen | 100% | 12 | CO2 | 1.9 | 3 | 0.38 | 0.38 | 0.3 | 25.6 | strong burr |
| 4 | no | 1 | pure oxygen | 100% | 15 | CO2 | 2.5 | 8 | 0.19 | 0.19 | 0.5 | 24.7 | small burr |
| 5 | no | 1.6 | pure oxygen | 100% | 3 | CO2 | 1.9 | 10 | 0.11 | 0.11 | 1.3 | 25.6 | very good |
| 6 | no | 1.6 | pure oxygen | 100% | 15 | CO2 | 3 | 7 | 0.26 | 0.26 | 0.5 | 24 | strong burr |
| 7 | no | 0.8 | Air | 20% | 9 | CO2 | 4 | 20 | 0.12 | 0.02 | 10.8 | 9 | small burr |
| 8 | no | 0.8 | Air | 20% | 9 | CO2 | 4 | 3 | 0.80 | 0.16 | 1 | 23.8 | small burr |
| 9 | no | 1.6 | Air | 20% | 4 | CO2 | 3.8 | 10 | 0.23 | 0.05 | 5.5 | 17 | small burr |
| 10 | no | 1.6 | Air | 20% | 9 | CO2 | 3.8 | 4 | 0.57 | 0.11 | 0.5 | 23.3 | small burr |
| 11 | no | 1.6 | pure oxygen | 100% | 3 | Disk | 4 | 32 | 0.08 | 0.08 | 7 | 26.5 | small burr |
| 12 | no | 1.6 | pure oxygen | 100% | 10 | Disk | 4 | 7 | 0.34 | 0.34 | 4.5 | 27.1 | small burr |
| 13 | no | 0.8 | pure oxygen | 100% | 5 | Disk | 4 | 42 | 0.06 | 0.06 | 28.4 | 17 | small burr |
| 14 | no | 0.8 | pure oxygen | 100% | 5 | Disk | 4 | 5 | 0.48 | 0.48 | 3 | 25.7 | small burr |
| 1b | yes | 0.8 | pure oxygen | 100% | 12 | CO2 | 1.9 | 3 | 0.38 | 0.38 | 0.5 | 4.4 | very good |
| 2b | yes | 0.8 | pure oxygen | 100% | 15 | CO2 | 3 | 8 | 0.23 | 0.23 | 0.4 | 2.6 | very good |
| 4b | yes | 1 | pure oxygen | 100% | 12 | CO2 | 1.9 | 3 | 0.38 | 0.38 | 0.4 | 3.4 | very good |
| 5b | yes | 1.6 | pure oxygen | 100% | 3 | CO2 | 1.9 | 10 | 0.11 | 0.11 | 0.4 | 2.3 | very good |
| 6b | yes | 1.6 | pure oxygen | 100% | 15 | CO2 | 3 | 7 | 0.26 | 0.26 | 0.5 | 5.9 | very good |
| 7b | yes | 0.8 | Air | 20% | 9 | CO2 | 4 | 20 | 0.12 | 0.02 | 8.7 | 1.4 | very good |
| 8b | yes | 0.8 | Air | 20% | 9 | CO2 | 4 | 3 | 0.80 | 0.16 | 0.4 | 0.5 | very good |
| 9b | yes | 1.6 | Air | 20% | 4 | CO2 | 3.8 | 10 | 0.23 | 0.05 | 2.6 | 0.9 | very good |
| 10b | yes | 1.6 | Air | 20% | 9 | CO2 | 3.8 | 4 | 0.57 | 0.11 | 0.3 | 0.9 | very good |
| 11b | yes | 1.6 | pure oxygen | 100% | 3 | Disk | 4 | 32 | 0.08 | 0.08 | 1 | 3.3 | very good |
| 12b | yes | 1.6 | pure oxygen | 100% | 10 | Disk | 4 | 7 | 0.34 | 0.34 | 0.3 | 2.9 | very good |
| 13b | yes | 0.8 | pure oxygen | 100% | 5 | Disk | 4 | 42 | 0.06 | 0.06 | 4.9 | 8.9 | very good |
| 14b | yes | 0.8 | pure oxygen | 100% | 5 | Disk | 4 | 5 | 0.48 | 0.48 | 0.4 | 0.6 | very good |

TABLE 2

| | Pre-coated steel sheet | | Laser welding | | | Weld | | |
|---|---|---|---|---|---|---|---|---|
| | characteristics | | parameters | | | characterisation | | |
| | | steel strip | | Welding | Filler | | | Hardness |
| | | Thicknesses | Power | speed | wire speed | % Al | % Al oxides with | drop in |
| Modality | Brushing | (mm) | (kW) | (m/min) | (m/min) | dissolved | diameter < 4 μm | the weld? |
| 15 | no | 1.6/1.6 | 5 | 5 | 1.8 | 0.14 | 0.6% | no |
| 16 | no | 0.8/1.6 | 5 | 5 | 1.5 | 0.09 | not investigated | no |
| 15b | yes | 1.6/1.6 | 5 | 5 | 1.8 | 0.11 | 0.3% | no |
| 16b | yes | 0.8/1.6 | 5 | 5 | 1.5 | 0.06 | not investigated | no |
| 17b | yes | 0.8/0.8 | 3.5 | 6 | 1.0 | 0.09 | not investigated | no |

What is claimed is:

1-23. (canceled)

24: A method for producing a precoated steel blank, the method comprising the successive steps of:
providing a precoated steel strip including a steel substrate having, on at least one main face, a precoating, the precoating including an intermetallic alloy layer and a metallic layer extending atop the intermetallic alloy layer, the metallic layer being a layer of aluminum, a layer of aluminum alloy or a layer of aluminum-based alloy; and
laser cutting the precoated steel strip in order to obtain at least one precoated steel blank, the precoated steel blank including a laser cut edge surface resulting from the laser cutting, the laser cut edge surface including a substrate portion and a precoating portion;
wherein the laser cutting is carried out in such a way that the substrate portion of the laser cut edge directly resulting from the cutting operation has an oxygen content greater than or equal to 15% in weight.

25: The method as recited in claim 24 wherein the laser cutting is performed using an assist gas containing at least 10% of Oxygen in weight.

26: The method as recited in claim 25 wherein the assist gas contains at least 18% of Oxygen in weight.

27: The method as recited in claim 26 wherein the assist gas is pure oxygen.

28: The method as recited in claim 24 wherein a product of the linear energy of the laser used for the laser cutting operation by the oxygen content in volume % of the assist gas is greater than or equal to 0.09 kJ/cm.

29: The method as recited in claim 24 further comprising performing a brushing operation after the laser cutting on at least part of the laser cut edge to form a brushed cut edge, the brushed cut edge including a brushed substrate portion and at least one brushed precoating portion.

30: The method as recited in claim 29 wherein the Aluminum content in weight of the brushed substrate portion is less than 6.0%.

31: The method as recited in claim 29 wherein the brushed cut edge (17) extends over an entire length of the laser cut edge.

32: The method as recited in claim 29 wherein the brushed cut edge extends over only part of the laser cut edge.

33: The method as recited in claim 24 wherein a product of the linear energy of the laser used for the laser cutting operation by the oxygen content in volume % of the assist gas is greater than or equal to 0.03 kJ/cm.

34: A method for manufacturing a welded blank, comprising the steps of:
producing a first and a second precoated steel blank, at least one among the first and the second precoated steel blanks being produced using the method as recited in claim 24 to form a laser cut edge on at least one of the precoated steel blanks;
butt welding a weld edge of the first precoated steel blank to a weld edge of the second precoated steel blank so as to create a weld joint between the first and second precoated steel blanks and thus obtain a welded blank, whereby the butt welding step includes a step of arranging the first and second precoated steel blanks in such a manner that the laser cut edge of at least one of the first and second precoated steel blanks is one of the weld edges.

35: The method as recited in claim 34 wherein the welding operation is a laser welding operation.

36: The method as recited in claim 34 further comprising, prior to the butt-welding step, a step of removing, for at least one of the first and second precoated steel blanks, the metallic layer in a removal zone adjacent to the weld edge of said precoated steel blank.

37: The method as recited in claim 36 wherein the removal of the metallic layer is performed using a laser beam.

38: The method according to claim 36 wherein, during the removal step, the intermetallic alloy layer is left in the removal zone over at least a portion of its height.

39: The method as recited in claim 35 wherein the laser welding operation is performed using a filler wire or powder addition.

40: The method as recited in claim 39 the filler wire or powder contains austenite-forming alloying elements.

41: A method for manufacturing a press-hardened steel part comprising the successive steps of:
carrying out the method as recited in claim 34 in order to obtain a welded blank;
heating said welded blank so as to obtain an at least partly austenitic structure said welded blank;
hot forming the welded blank in a press to obtain a press-formed steel part; and
cooling the steel part in the press so as to obtain the press-hardened steel part.

42: The method for manufacturing a steel part as recited in claim 41 wherein the cooling rate is equal to or greater than the critical martensitic or bainitic cooling rate of the steel blanks.

43: A precoated steel blank comprising:
a steel substrate portion having, on at least one face, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blank being comprised between 0.5 mm and 5 mm, and
at least one laser cut edge extending between the faces of the precoated steel blank and including a substrate portion and at least one precoating portion, wherein the substrate portion of the laser cut edge has an oxygen content in weight greater than or equal to 15% and an aluminum content in weight less than or equal to 6.0%.

44: A precoated steel blank comprising:
a steel substrate portion having, on at least one face, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blank being comprised between 0.5 mm and 5 mm, and
at least one brushed cut edge extending between the faces of the precoated steel blank and comprising a brushed substrate portion and at least one brushed precoating portion, wherein the oxygen content in weight of the brushed substrate portion is greater than or equal to 0.5% and the aluminum content in weight of the brushed substrate portion is less than 6.0%.

45: A welded blank comprising:
a first and second precoated steel blank, each precoated steel blank including a steel substrate portion having, on at least one face, a precoating portion, the precoating portion including an intermetallic alloy layer portion and a metallic layer portion extending atop the intermetallic alloy layer portion, the metallic layer portion being a layer of aluminum, a layer of aluminum alloy or a layer of aluminum-based alloy, the thickness of the precoated steel blanks being comprised between 0.5 mm and 5 mm; and
a welded zone joining the first and second precoated steel blank, wherein the aluminum content in weight of the welded zone is less than or equal to 0.3% and wherein the welded zone contains at least 0.2% in volume of Aluminum oxide particles having a diameter less than or equal to 2 micrometers.

46: The welded blank as recited in claim 45 wherein the welded zone contains at least 0.4% in volume of Aluminum oxide particles having a diameter less than or equal to 2 micrometers.

47: A press hardened part made by press hardening the welded blank as recited in claim 45.
